(19) United States
(12) Patent Application Publication
(10) Pub. No.: US 2013/0077283 A1
(43) Pub. Date: Mar. 28, 2013

(54) APPARATUSES AND METHODS FOR HIGH-EFFICIENCY POLARIZATION CONVERSION IN A PROJECTION LIGHT ENGINE

(71) Applicant: Lin Li, Boise, ID (US)

(72) Inventor: Lin Li, Boise, ID (US)

(21) Appl. No.: 13/243,871

(22) Filed: Sep. 23, 2011

(51) Int. Cl. F21V 9/14

(52) U.S. Cl. 362/19

(57) ABSTRACT

Apparatuses and methods are disclosed, including light source modules for supplying primary and secondary polarized light using a polarization conversion system that supplies a first portion of a light beam with a first polarization as a primary light beam and supplies a polarization-converted second portion of the light beam as a secondary light beam in generally the same direction as the primary light beam to illuminate a microdisplay for projection of an image.

### BACKGROUND

Embodiments of the present invention are related generally to the field of projection light engines and, more particularly, to apparatuses and methods for high-efficient polarization conversion in a projection light engine.

Miniature electronic image projectors utilize solid state light sources, such as light emitting diodes (LEDs), as a light source to illuminate a reflective liquid-crystal-on-silicon (LCOS) panel or transmissive liquid crystal display (LCD). LEDs are utilized in miniature projectors because of the small size, long life span and wide color gamut of the LEDs in comparison to incandescent lamps, as well as because of the efficiency of the LEDs in producing lumens per Watt. One disadvantage to using LEDs in miniature projectors is that LCOS and LCD panels require polarized light for illumination and LEDs produce non-polarized light. As a result, conventional projectors can suffer from low light output and low lumen per Watt efficiency due to polarization light loss.

Conventional polarization conversion systems (PCS) have been used to linearly polarize the light from LEDs or lamps for liquid crystal based projectors. Some of these conventional PCSs have been relatively large which can make them unsuitable for use in miniature projectors. Other conventional PCSs can improperly increase the cross sectional area of the light beam, also referred to as etendue, to dimensions that require other components of the miniature projector to be increased to proportions unsuitable for use in miniature projectors.

The foregoing examples of the related art and limitations related therewith are intended to be illustrative and not exclusive. Other limitations of the related art will become apparent to those of skill in the art upon a reading of the specification and a study of the drawings.

### BRIEF DESCRIPTION OF THE DRAWINGS

FIG. 1 is a diagrammatic view which illustrates components and system architecture of a light engine for image projection, including a light source module that is arranged according to an embodiment of the present disclosure.

FIG. 2 is a diagrammatic view illustrating components and operation of the light source module shown in FIG. 1.

FIG. 3 is a diagrammatic view illustrating component configuration during operation of the light source module shown in FIGS. 1 and 2.

FIG. 4 is a diagrammatic view illustrating another embodiment of a light source module for use as a sub-system of the light engine.

FIG. 5 is a diagrammatic view which illustrates an embodiment of components of the light source module.

FIG. 6 is a diagrammatic view which illustrates another embodiment of components of the light source module.

FIG. 7 is a diagrammatic view illustrating an embodiment of a light supply arrangement utilizing multiple light modules for supplying polarized light in a light engine.

FIG. 8 is a diagrammatic view illustrating another embodiment of a light supply arrangement utilizing multiple light modules for supplying polarized light in a light engine.

FIG. 9 is a flow diagram illustrating an embodiment of a method for supplying polarized light using a light module.

FIG. 10 is a flow diagram illustrating another embodiment of a method for supplying polarized light using a light module.

### DETAILED DESCRIPTION

The following description is presented to enable one of ordinary skill in the art to make and use the invention and is provided in the context of a patent application and its requirements. Various modifications to the described embodiments will be readily apparent to those skilled in the art and the generic principles taught herein may be applied to other embodiments. Thus, the present invention is not intended to be limited to the embodiments shown, but is to be accorded the widest scope consistent with the principles and features described herein including modifications and equivalents, as defined within the scope of the appended claims. It is noted that the drawings are not to scale and are diagrammatic in nature in a way that is thought to best illustrate features of interest. Descriptive terminology may be adopted for purposes of enhancing the reader's understanding, with respect to the various views provided in the figures, and is in no way intended as being limiting.

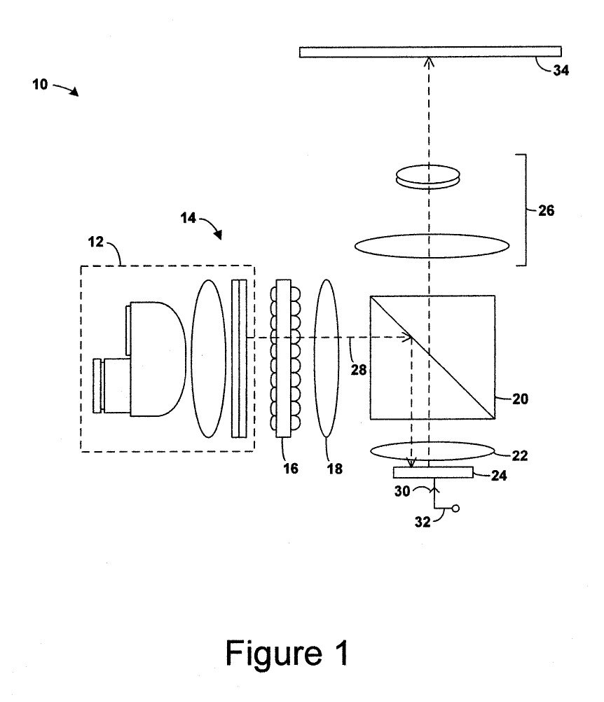

Attention is now directed to the figures wherein like items may refer to like components throughout the various views. FIG. 1 is a diagrammatic representation of a light engine configuration, produced according to an embodiment of the present disclosure, and generally indicated by the reference number 10. Light engine 10 includes a compact and highly efficient polarization conversion system (PCS) for increased polarized light availability in projection displays with high light output and low power consumption requirements. Light engine 10 includes an LED light source module 12 having a polarization conversion system (PCS) 14 (as will be discussed), a fly's eye lenslet array 16, condenser lens 18, a polarizing beam splitter (PBS) 20, a field lens 22, a liquid-crystal-on-silicon (LCOS) panel 24 and a projection lens assembly 26. A light beam 28 is shown in FIG. 1 in simplified form for purposes of discussing the various components. Light beam 28 can take on several different characteristics from the time that the light beam is generated by the light source module until the light beam reaches the surface on which the light is projected, as will be discussed.

Light source module 12 can provide multi-colored polarized light beam 28 with a non-uniform irradiance distribution to lenslet array 16. Lenslet array 16 divides the non-uniform irradiance distribution to multiple sub-apertures and then the sub-apertures are superimposed together to provide a uniform irradiance distribution at the focal plane of the condenser lens 18. The light beam from the lenslet array passes through condenser lens 18 which focuses the light beam into PBS 20. PBS 20 splits the beam of light so that only light having the correct polarization reaches LCOS panel 24. Since light beam 28 is polarized when it is supplied by light source module 12, substantially all of light beam 28 is reflected in PBS 20 and reaches field lens 22. Field lens 22 can provide telecentric illumination and reduce the dimension of the illumination system. LCOS panel 24 can receive a data signal 30 on a data line 32 with video information for display. The light beam reflects off of the LCOS panel and is modulated by the video information before passing through the PBS to the projection lens assembly. The projection lens assembly enlarges and projects the image of the LCOS panel on a projection screen 34 or other surface. The various components of the light engine, other than the light source module, can be modified, substituted or changed in any suitable manner so long as operational compatibility with the subject light source module is maintained as is known to a person of ordinary skill in the art to utilize the improved polarized light output of the light source module disclosed herein.

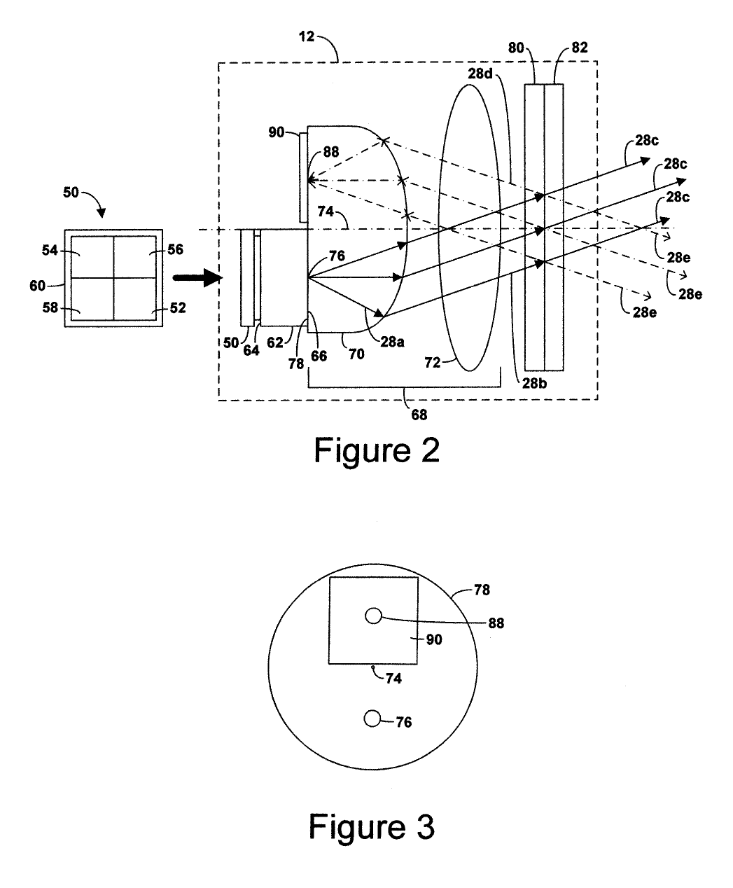

FIG. 2 is a diagrammatic illustration of light source module 12 with polarization conversion system 14 (FIG. 1) is shown. Light source module 12 includes an LED assembly 50 that is shown in FIG. 2 in position for operation and is also shown in more detail in a supplemental view for purposes of illustration. LED assembly 50 can have an array of LED dies with one red die 52, one blue die 54 and two green dies 56 and 58 arranged in a 2×2 array on a substrate 60. The LED assembly can have one or multiple dies with single or different colors. The LED dies can be mounted in substantially the same plane in a spaced apart relationship. The LED assembly can be driven from a power source (not shown) to produce the light beam 28. LED assembly 50 can be positioned in the light source module 12 with the LED dies facing the right hand side of FIG. 2 to supply the multi-colored light beam in a non-collimated and non-polarized state.

In the embodiment shown in FIG. 2, light source module 12 includes a light tunnel 62 that is positioned to receive light beam 28 from the LED assembly in a first end 64 and to emit the light beam from a second end 66 at a collimating lens assembly 68. The light tunnel can mix the different colors of light from the different LED dies 52, 54, 56 and 58 in the light beam to improve color uniformity in comparison to not using the light tunnel. Light tunnel 62 can be short and/or tapered, and can be solid or hollow. The first end of the light tunnel can be placed very close to the LED dies for receiving a majority of the light produced by the dies. In some instances, an air gap can exist between the LED dies and the first end of the light tunnel. In these instances, the air gap can be filled with an index matching material for improved coupling efficiency. The second end of the light tunnel can be attached to the planar surface of the plano-convex lens. In the light source module, light tunnel 62 can serve as an interface between the LED dies and the collimating lens assembly. LED assembly 50 can be considered as one embodiment of a light source; and light tunnel 62 can be part of the light source along with the LED assembly when the light tunnel is included. The mixed color light can be emitted from the light tunnel in a divergent pattern.

Light source module 12 can include collimating lens assembly 68 for receiving the light beam emitted from the light tunnel or LED assembly in a divergent pattern and for transforming the light beam from divergent to a collimated beam. Collimating lens assembly 68 can include a plano-convex lens 70 and a relay lens 72 that are aligned with one another on a common optic axis 74 to collimate the light beam. Other lens arrangements can be used in the collimating lens assembly to collimate the divergent light from the light tunnel or LED assembly. Relay lens 72 can be aspheric or other shapes, and plano-convex lens 70 can have a spherical surface, aspheric profile or other shapes or can be replaced with a concave-convex lens, similar to a meniscus lens.

Light tunnel 62, in the present embodiment, is diagrammatically shown as emitting divergent light beam 28a (shown using a set of divergent rays) from an emitting area 76 that is laterally offset from optic axis 74. Light beam 28 is shown as if emitted from a point source for purposes of illustrative clarity, however it should be understood that the light beam can be emitted from the entire end surface of the light tunnel. FIG. 3 illustrates planar surface 78 of plano-convex lens 70 which is oriented such that optical axis 74 is normal to the page. Optical axis 74 is positioned substantially in the center of planar surface 78 while emitting area 76, where the light beam enters the plano-convex lens, is laterally offset from the optical axis. FIGS. 2 and 3 are diagrammatic and not to scale such that image area 76 may be smaller or larger than what is shown in FIGS. 2 and 3.

Referring again to FIG. 2, collimating lens assembly 68 converts divergent light beam 28a into a collimated light beam 28b as is demonstrated by a plurality of parallel rays. Collimated light beam 28b is multi-colored, collimated, and is non-polarized. Since the emitting area where divergent light beam 28a enters the collimating lens assembly 68 is laterally offset from optical axis 74, collimated light beam 28b is not parallel to optical axis 74. After the light beam is collimated, the light beam passes to a quarter wave plate 80 and reflective polarizer 82. The quarter wave plate and reflective polarizer can be an assembly that includes anti-reflective coated cover glasses with laminated quarter wave film and reflective polarizer film. Quarter wave plate 80 and reflective polarizer 82 cooperate to pass a first portion 28c of the light beam that is of a first polarization. The first portion of the light beam passed through the reflective polarizer can be referred to as primary polarized light beam 28c (shown as a set of parallel rays) and can be substantially all S-polarized light.

A second portion of collimated light beam 28d (parallel rays), which can be P-polarized light, is reflected by reflective polarizer 82. Reflected light beam 28d passes back through collimating lens assembly 68 to produce an image of the light source at an image area 88 that is laterally offset from emitting area 76 of the light source, as shown in FIG. 2 in conjunction with FIG. 3. As shown in FIG. 3, image area 88 can be laterally offset from center axis 74. Reflected light beam 28d can be focused in image area 88 on a reflector 90 that is positioned laterally offset from emitting area 76 where the light beam enters the plano-convex lens. Reflector 90 can be a reflective film or minor surface on the plano-convex lens or any other suitable reflective device having a reflective surface that can be positioned laterally offset from the emitting area 76 or the light source. Reflector 90 re-reflects light beam 28d back through collimating lens assembly 68 and back through quarter wave plate 80 to reflective polarizer 82.

Since the second portion of the collimated light beam passes through the quarter wave plate 80 two times subsequent to first reflecting off of reflective polarizer 82, the polarization of the second portion of the light beam is converted to the first polarization and is now transmitted by the polarizer 82 as polarized light beam 28e (parallel rays) which can be referred to as a secondary polarized light beam. Polarized light beam 28e has the same polarization as polarized light beam 28c, which can be S-polarization. Polarized light beam 28e supplied by light source module 12 with polarization conversion system 14 can be transmitted to lenslet array 16 along with polarized light beam 28c for use by the remainder of light engine 10. In the light source module, the light source can be referred to as the primary light source and the reflector can be referred to as a secondary light source. Polarized light exiting the light source module without having been reflected by the reflective polarizer can be referred to as direct light, while the polarized light exiting the light source module after being converted by the polarization conversion system can be referred to as recycled light.

Both plano-convex lens 70 and relay lens 72 are configured such that a sharp (e.g., focused) image of the light source is formed on the reflective surface of reflector 90. This allows the reflector to serve as a secondary light source that preserves etendue. The reflective relay system which images the light source on the reflector can be telecentric and can have a magnification of one. When the light tunnel is used, the secondary light source can have the same format as the exit end of the light tunnel with mixed colors. When the light tunnel is not used and the LED assembly is placed very close to the plano-convex lens, the secondary light source can mimic the primary source by imaging the individual color dies of the primary source.

Polarization conversion system 14 can include the components of light source module 12 other than the light source, (e.g., LED assembly 50) which converts polarized light from one polarization to an orthogonal polarization. In the embodiment shown in FIG. 2, the polarization conversion system can include reflector 90 positioned offset from the primary light source, the collimating lens assembly 68, the quarter wave plate 80, and the reflective polarizer 82. The polarization conversion system serves to enhance the illumination of the LCOS panel 24 for higher brightness on the projection screen.

The polarization conversion system can essentially double the angular size of the light beam in one direction because of the angles at which light beams 28c and 28e leave the reflective polarizer. In an embodiment, the combination of light beams 28c and 28e can create, after passing through lenslet array 16, condenser lens 18 and field lens 22, a rectangular illumination shape that can approximately match a 16:9 format size of the LCOS panel which is located in the focal plane of the condenser lens. Lenses 18 and 22 can be arranged to maintain the rectangular beam shape and to size the beam for application of the beam to the LCOS panel.

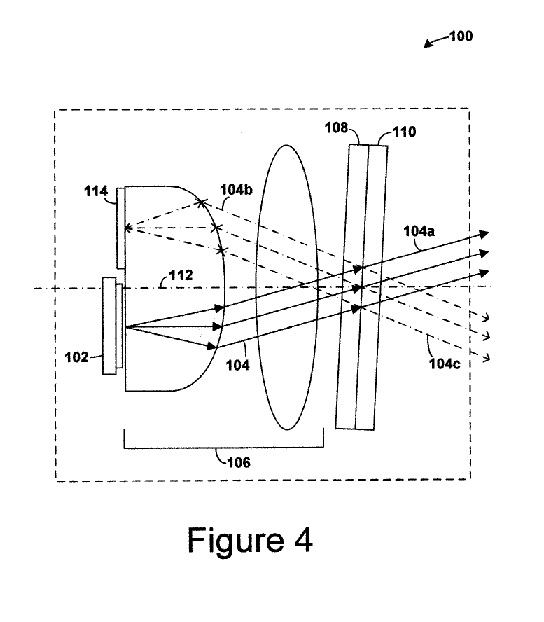

FIG. 4, shows another embodiment of a light source module having a polarization conversion system. It is noted that aspects of the operation of this embodiment will be familiar to the reader based on FIGS. 1-3 and their associated descriptions. Light source module 100 includes a light source 102 that generates a light beam 104 and directs the light beam through a collimating arrangement 106 which collimates the light beam before the light beam reaches a quarter wave plate 108 and reflective polarizer 110. Collimating arrangement 106 includes an optical center axis 112. Reflective polarizer 110 polarizes and passes a first portion 104a of the light beam. A second portion 104b of the light beam is reflected from the reflective polarizer and is focused back through the collimating arrangement to a reflector 114. The beam is then re-reflected from the reflector back through the collimating arrangement to the quarter wave plate and reflective polarizer. When the second portion of the light beam returns to the reflective polarizer, the beam is transmitted, as indicated by reference number 104c. Since the light beam has passed through the quarter wave plate two more times than light beam 104a, light beam 104c has been converted to the same polarization as the first portion 104a of the light beam.

In the embodiment shown in FIG. 4, light source 102 is not completely offset from center axis 112 in that a portion of the light source overlaps the center axis such that light could be emitted from either side of the center axis. Also, reflector 114 is not positioned symmetrically across the center axis from the light source. As shown in FIG. 4, quarter wave plate 108 and reflective polarizer 110 can be angled with respect to normal relative to the optical axis. In another embodiment, reflective polarizer 110 can be positioned at an angle without the quarter wave plate also being angled with respect to the optical axis. Reflector 90 can also be angled with respect to perpendicular to the optical axis to direct the reflected light back to the reflective polarizer. The angle of the reflective polarizer can be selected to direct an image of the reflected light beam on the reflector and the angle of the reflector can be selected to re-reflect the light beam back to the reflective polarizer. However, there is an upper limit to the amount that the reflective polarizer can be angled before the reflective polarizer suffers from polarization light leakage, requires larger dimensions and demonstrates low performance. For example, angling the reflective polarizer at about 45 degrees with respect to normal to the optical axis can introduce some of these negative issues to the operation of the reflective polarizer. Having the light source positioned closer to the center axis while producing an image of the light source with the second portion of the light beam at the area laterally offset from the light source may offer an increased efficiency over having the light source and its image on the reflector symmetrically across the center axis because this arrangement can increase the usage of direct light which is brighter than the recycled light. The embodiment of FIG. 2 can be readily modified in view of FIG. 4.

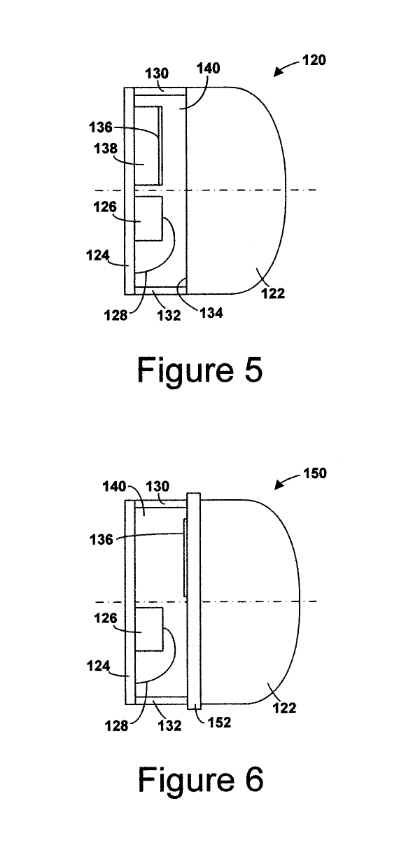

In FIG. 5, an LED package 120 having a plano-convex lens 122 is shown. LED packages can be used as assemblies to group some of the components of the light source module and can be used in conjunction with a relay lens, quarter wave plate and reflective polarizer. LED package 120 includes a substrate 124 on which are mounted LED dies 126 which can be electrically connected to the substrate for power using a wire bond 128. LED dies 126 serve as a light source in this embodiment. Substrate 124 can be connected to plano-convex lens 122 using spacers 130 and 132 which position the LED dies in a spaced apart relationship with a planar surface 134 of plano-convex lens 122. A reflector 136 (e.g., a mirror) can be mounted to a support 138 to support the reflector with the substrate laterally offset from the LED dies. A space between the LED dies and the planar surface and between the reflector and the planar surface can be filled with an index matching material 140 that has an index of refraction that is substantially the same as the index of refraction of plano-convex lens 122. The index matching material can reduce reflection at the planar surface to increase efficiency.

In LED package 120 shown in FIG. 5, LED die 176 and reflector 136 are laterally offset from one another and are substantially co-planar. Light exits the LED die in substantially the same plane as the reflective surface of the reflector. However, the LED die and the reflective surface are not required to be substantially co-planar. By adjusting the optics, a sharp image of the LED die light source can be imaged on the reflector laterally offset from the light source regardless of whether the reflective surface is positioned longitudinally ahead or behind the light source relative to the direction of the light supplied by the light source.

Another embodiment of an LED package is shown in FIG. 6 and is indicated by the reference number 150. LED package 150 represents an embodiment in which LED dies 126 are arranged longitudinally behind reflector 136 (e.g., reflective film). In this embodiment, the LED package includes a cover glass 152 that is attached to the planar surface of the plano-convex lens on one surface and has the reflector attached to another opposite surface. In this embodiment, since the reflector contacts the plano-convex lens, there is no index matching material 140 between the plano-convex lens and the reflector as in the embodiment shown in FIG. 5. As can be seen based on the embodiments of the LED packages illustrated in FIGS. 5 and 6, a light tunnel may not be needed if the reflector is embedded in the LED package.

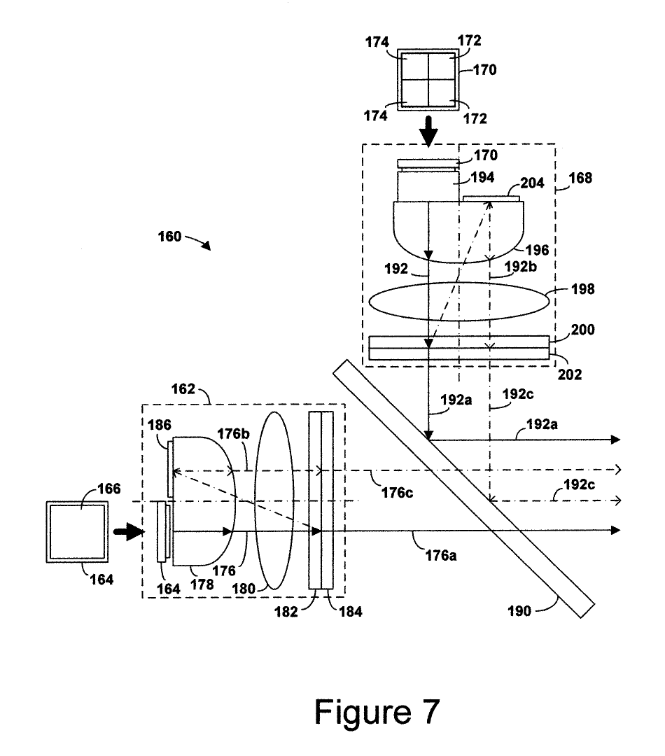

As shown in FIG. 7, multiple light source modules can be used together in a light supply arrangement 160 to increase the amount of light supplied to the LCOS panel for enhancing image brightness at the projection screen. Light beams are simplified to individual rays in the embodiment shown in FIG. 7 for illustration purposes. In the embodiment shown in FIG. 7, the light supply arrangement can include two different light source modules each of which includes a polarization conversion system. A light source module 162 can include a light source 164 that has one or more green LED dies 166 and produces only green light or one or more white LED dies and produces white light. The number of green LED dies can be more than the number of either of the red or blue LED dies to increase the overall light quantity without adversely affecting the color balance visually perceived at the projection screen. A light source module 168 can include a light source 170 that has one or more red LED dies 172 and one or more blue LED dies 174 to produce red and blue light. The blue, green and red dies can have other arrangements (such as red dies in light source 164 and green/blue dies in light source 170) and one or more white LED can be used.

Light source 164 produces a green light beam 176 that is collimated by plano-convex lens 178 and relay lens 180 before reaching a quarter-wave plate 182 and reflective polarizer 184. A first portion of the green light beam 176a is passed through the quarter-wave plate and reflective polarizer and emerges as a polarized green light beam 176a with a first polarization. A second portion of the green light beam 176b is reflected by the reflective polarizer, re-reflected by a reflector 186 and is converted to have the first polarization before emerging as polarized green light beam 176c from the quarter-wave plate and reflective polarizer. The second portion of the green light beam passes through the quarter-wave plate twice to be converted to the first polarization direction. Polarized green light beams 176a and 176c pass through a dichroic plate 190 after which the beam can reach a fly's eye lenslet array and other components of the light engine, as described above, and shown, for example, in FIG. 1.

Light source 170 of light module 168 produces a red and blue light beam 192 which passes through a light tunnel 194 where the red and blue light from the red and blue LED dies are mixed. Light beam 192 is collimated by plano-convex lens 196 and relay lens 198 before reaching a quarter-wave plate 200 and reflective polarizer 202. A first portion 192a of the light beam is polarized to a first polarization and is passed through the quarter-wave plate and reflective polarizer to the dichroic plate 190. Dichroic plate 190 reflects and directs the first portion of the mixed red and blue light beam to the fly's eye lenslet array (see, for example, FIG. 1). A second portion 192b of the light beam is reflected by the reflective polarizer 202, re-reflected by a reflector 204 and is converted to have the first polarization before emerging from the quarter-wave plate and reflective polarizer as light beam 192c. The second portion 192b of the light beam passes through the quarter-wave plate twice to be converted to the first polarization direction. Light beam 192c is reflected from dichroic plate 190 and directed to the fly's eye lenslet array.

Providing multiple light source modules in the light engine can increase the overall brightness seen at the projection screen. Larger LED dies, or more LED dies can be used when multiple light source modules are used. Any one of the light source modules or all of the light source modules can utilize LED modules as described in FIGS. 5 and 6. Each of the light source modules in the multiple light source module arrangement can have single or multiple LED dies and the light source modules can be arranged in a different order relative to the dichroic plate.

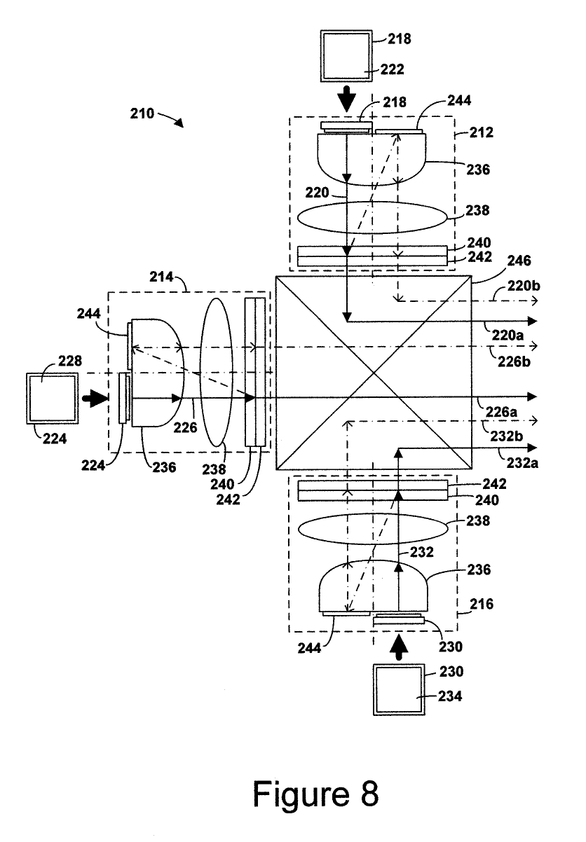

Referring now to FIG. 8, another embodiment of a light supply arrangement having multiple light source modules is generally indicated by reference number 210. Light supply arrangement 210 includes a blue light module 212, a green light module 214 and a red light module 216. The blue light module includes a blue light source 218 that produces a blue light beam 220 from at least one blue LED die 222. The green light module includes a green light source 224 that produces a green light beam 226 from at least one green LED die 228. The red light module includes a red light source 230 that produces a red light beam 232 from at least one red LED die 234. Each of the light modules 212, 214 and 216 can have any suitable embodiment of the polarization conversion system previously discussed including a positive lens 236, a relay lens 238, a quarter-wave film 240, a reflective polarizer 242, and a reflector 244. Light module 212 produces a blue primary polarized light beam 220a and a blue secondary polarized light beam 220b; light module 214 produces a green primary polarized light beam 226a and a secondary polarized light beam 226b; and light module 216 produces a red primary light beam 232a and a secondary polarized light beam 232b.

Light supply arrangement 210 can include a dichroic X-cube 246 or a dichroic X-plate. The dichroic X-cube mixes the different colored primary and secondary light beams from the light modules and directs the light beams in substantially the same direction toward a fly's eye lenslet array (see, for example, FIG. 1). Light supply arrangement 210 can provide for an increased light output since multiple light modules are used. Each of the different colored light modules can have single or multiple LED dies to provide different levels of light output and color balance to the LCOS panel.

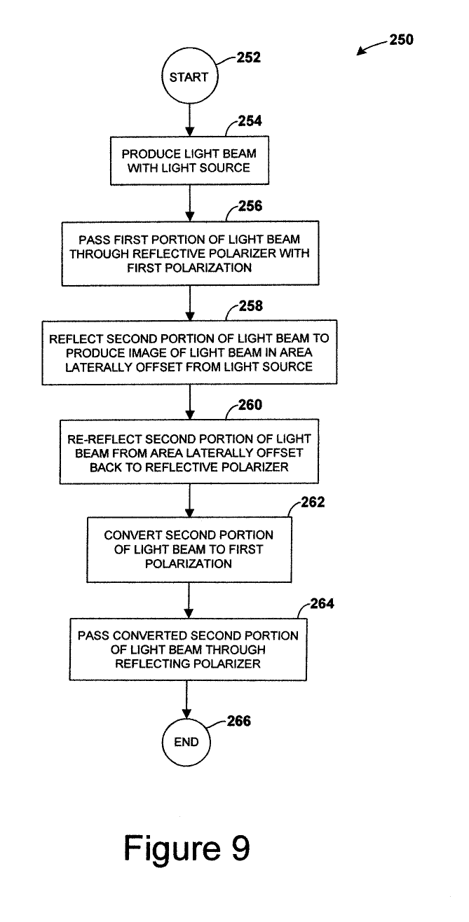

Referring now to FIG. 9, a method for supplying polarized light is generally indicated by the reference number 250. Method 250 begins at a start 252 and proceeds to a step 254 where a light beam is produced by a light source. Method 250 then proceeds to step 256 where a first portion of the light beam is passed through a reflective polarizer, the first portion having a first polarization thereafter. Method 250 then proceeds to step 258 where a second portion of the light beam is reflected from the reflective polarizer such that an image of the light beam is produced in an area that is laterally offset from the light source. Next, method 250 then proceeds to step 260 where the second portion of the light beam is re-reflected from the area laterally offset from the light source back to the reflective polarizer. Method 250 then proceeds to step 262 where the second portion of the light beam is converted from a second polarization to the first polarization as the second portion travels between the reflective polarizer and the laterally offset area. Step 262 is not limited to occurring after step 260. Following step 262, method 250 proceeds to step 264 where the converted second portion of the light beam is passed through the reflective polarizer. After step 264, method 250 ends at step 266.

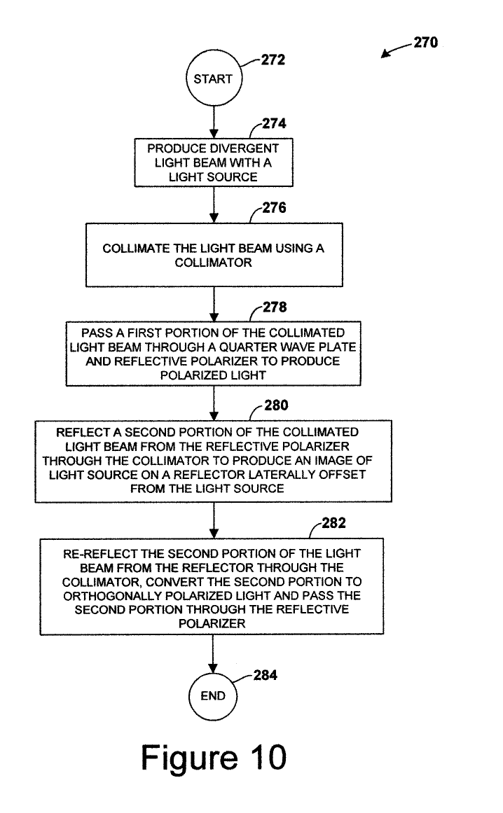

FIG. 10 illustrates another embodiment of a method for supplying polarized light generally indicated by reference number 270. Method 270 begins at a start step 272 and proceeds to a step 274 where a divergent light beam is produced. Method 270 then proceeds to step 276 where the divergent light beam is collimated into a collimated light beam with a collimating lens arrangement. Method 270 then proceeds to step 278 where a first portion of the collimated light beam is passed through a quarter wave plate and reflective polarizer, the first portion thereafter having an S polarization. Method 270 then proceeds to a step 280 where a second portion of the collimated light beam is reflected from the quarter wave plate and reflective polarizer such that the second portion passes back through the collimating lens arrangement and produces an image of the light beam on a reflector at a position laterally offset from the light source. Method 270 then proceeds to step 282 where the second portion of the collimated light beam is re-reflected from the reflector through the collimating lens assembly and is passed through the quarter wave plate and reflective polarizer to convert the re-reflected second portion of the collimated light beam to S-polarized light. Following step 282, method 270 proceeds to step 284 where the method ends.

The light modules disclosed herein with the polarization conversion system can provide a gain in efficiency over conventional systems that do not offer polarization conversion. By re-imaging the primary light source onto the offset reflector and converting the light reflected by the reflective polarizer, the polarization conversion system can significantly improve the amount of light supplied to the LCOS panel to improve the brightness of the image on the projection screen. Also, since the polarization conversion system produces more polarized light for a given LED light output, lower power consumption can be achieved by decreasing the amount of light that is needed from the LEDs while maintaining the level of light output to the LCOS panel. Another advantage of the disclosed light module is that the negative impacts to cost and dimension are considered as very limited because the relay lenses are shared by direct light and recycled light.

The foregoing description of the invention has been presented for purposes of illustration and description. It is not intended to be exhaustive or to limit the invention to the precise form or forms disclosed, and other modifications and variations may be possible in light of the above teachings wherein those of skill in the art will recognize certain modifications, permutations, additions and sub-combinations thereof.

What is claimed is:

1. A method for supplying polarized light, comprising:
producing a light beam from a light source;
passing a first portion of the light beam through a reflective polarizer, the first portion thereafter having a first polarization;
reflecting a second portion of the light beam from the reflective polarizer such that an image of the light source is produced in an area laterally offset from the light source;
re-reflecting the second portion of the light beam from the area laterally offset from the light source back to the reflective polarizer;
converting the second portion of the light beam from a second polarization to the first polarization as the second portion travels between the reflective polarizer and the laterally offset area; and
passing the converted second portion of the light beam through the reflective polarizer such that the converted second portion is emitted in combination with the first portion.

2. The method of claim 1 further comprising:
reflecting the second portion of the light beam from the reflective polarizer non-normal to the light beam to produce the image of the light source at the area laterally offset from the light source.

3. A method as defined in claim 1, the method further comprising:
collimating the divergent light beam with a collimating lens arrangement into a collimated light beam before passing the first portion of the light beam through the reflective polarizer.

4. The method of claim 3, further comprising:
passing the reflected second portion of the light beam from the reflective polarizer through the collimating lens arrangement before the image of the light source is produced at the area laterally offset from the light source; and
re-passing the re-reflected second portion of the light beam from the area laterally offset from the light source back to the reflective polarizer through the collimating lens arrangement.

5. The method of claim 3 wherein the collimating lens arrangement includes an optical center axis, the method further comprising:
producing the light beam from the light source such that the light beam is at least partially offset from the center axis of the collimating lens arrangement to produce the image of the light source at the area laterally offset from the light source.

6. The method of claim 1, the method further comprising:
collimating the divergent light beam with a collimating lens arrangement into a collimated light beam before passing the first portion of the light beam through the reflective polarizer, the collimating lens arrangement including an optical center axis; and
reflecting the second portion of the light beam from the reflective polarizer non-normal with respect to the light beam in cooperation with producing the light beam from the light source such that the light beam is at least partially offset from the center axis of the collimating lens arrangement to produce the image of the light source at the area laterally offset from the light source.

7. The method of claim 1 wherein the first polarization of the first portion of the light beam is S-polarization and the second polarization of the second portion of the light beam is P-polarization.

8. The method of claim 1 wherein the light source includes at least two different light emitters that emit different colors of light with respect to one another, the method further comprising:
mixing the light from the light emitters using a light tunnel to create the light beam.

9. The method of claim 1, further comprising:
re-reflecting the second portion of the light beam with a reflector at an area that is substantially co-planar with an area where the light beam exits the light source.

10. The method of claim 1 wherein converting the second portion of the light beam from the second polarization to the first polarization includes passing the second portion of the light beam through a quarter wave plate in a reverse direction and a forward direction.

11. The method of claim 1 wherein the second portion of the light beam is reflected such that an image of the light source is focused in the area laterally offset from the light source.

12. The method of claim 1 wherein the second portion of the light beam is reflected such that an image of the light source is focused in the lateral area partially offset from the light source.

13. A method for supplying polarized light, comprising:
producing a divergent light beam;
collimating the divergent light beam with a collimating lens arrangement into a collimated light beam;
passing a first portion of the collimated light beam through a quarter wave plate and reflective polarizer, the first portion thereafter having an S-polarization;
reflecting a second portion of the collimated light beam from the reflective polarizer such that the second portion passes back through the collimating lens arrangement and produces an image of the light source on a reflector at a position laterally offset from the light source; and
re-reflecting the second portion of the collimated light beam from the reflector through the collimating lens assembly and passing the re-reflected light through the quarter wave plate and reflective polarizer to convert the re-reflected second portion of the collimated light beam to S-polarization light that is emitted in combination with the first portion.

14. A light source module comprising:
a light source for producing a light beam in a longitudinal direction;
a reflector arranged laterally offset from the light source with respect to the longitudinal direction of the light beam;
a reflective polarizer for converting a first portion of the light beam to a first polarization and passing the first portion of the light beam to exit the light module and for reflecting a second portion of the light beam, the reflective polarizer arranged to produce an image of the light source on the reflector with the second portion of the light beam, the reflector arranged to re-reflect the second portion of the light beam back to the reflective polarizer; and
a quarter wave plate arranged between the reflective polarizer and the reflector for converting the second portion of the light beam from a second polarization to the first polarization so that the converted second portion of the light beam can pass through the reflective polarizer and exit the light module along with the first portion.

15. The light source module of claim 14 wherein the reflective polarizer is arranged non-normal to the light beam to produce the image of the light source on the reflector laterally offset from the light source.

16. The light source module of claim 14 further comprising:
a collimating arrangement arranged for receiving the divergent light from the light source and for collimating the light beam prior to the light beam reaching the reflective polarizer.

17. The light source module of claim 16 wherein the collimating arrangement includes a plano-convex lens and a relay lens.

18. The light source module of claim 16 wherein the collimating arrangement is positioned between the reflective polarizer and the reflector such that the second portion of the light beam will pass through the collimating arrangement twice before exiting the light module with the first polarization.

19. The light source module of claim 16 wherein the collimating arrangement includes an optical center axis and the light source is positioned such that the light beam produced by the light source is at least partially laterally offset from the optical center axis.

20. The light source module of claim 19 wherein the reflector is positioned at least partially offset from the optical center axis.

21. The light source module of claim 14 wherein the light source includes different colors.

22. The light source module of claim 14 wherein the light source includes at least one LED die to produce the light beam.

23. The light source module of claim 22 wherein the light source includes multiple LED dies.

24. The light source module of claim 14 wherein the reflective polarizer is configured such that the first polarization is S-polarization.

25. The light source module of claim 14 further comprising:
a light tunnel for mixing different colors of light from the light source, the light tunnel arranged to receive the light beam from the light source and to supply a mixed light beam to the reflective polarizer.

26. The light source module of claim 14 further comprising:
a collimating arrangement;
a light tunnel for mixing different colors of light from the light source, the light tunnel arranged to receive the divergent light beam from the light source and to supply a mixed light beam to the collimating arrangement, the collimating arrangement arranged for receiving the divergent light from the light tunnel and for collimating the light beam prior to the light beam reaching the reflective polarizer.

27. The light source module of claim 14 wherein the light source and a reflective surface of the reflector are arranged substantially co-planar with one another.

28. A light source module arrangement, comprising:
first and second light source modules;
a dichroic plate, where the first and second light source modules are arranged to supply polarized light beams to the dichroic plate from different directions and the dichroic plate is arranged to receive the polarized light beams and to direct the polarized light beams in a single general direction.

29. A light source module arrangement, comprising:
first, second and third light source module;
a dichroic X-cube, where the first, second and third light source modules are arranged to supply polarized light beams to the dichroic X-cube from different directions and the dichroic X-cube is arranged to receive the polarized light beams and to direct the polarized light beams in a single direction.

30. A light emitter package, comprising:
a light source for producing a light beam in a longitudinal direction;
a reflector arranged laterally offset from the light source with respect to the direction of the light beam; and
a plano-convex lens connected to the light source and the reflector such that the light beam from the light source is at least partially collimated by the plano-convex lens, the light emitter package arranged to supply a primary collimated polarized light beam and a secondary collimated polarized light beam in generally the same direction in conjunction with the quarter wave plate and reflective polarizer.
